(19) United States
(12) Patent Application Publication
(10) Pub. No.: US 2015/0115835 A1
(43) Pub. Date: Apr. 30, 2015

(54) APPARATUS AND METHOD FOR CONTROLLING LIGHTING BASED ON INTERNET PROTOCOL NETWORK

(71) Applicant: Electronics and Telecommunications Research Institute, Daejeon (KR)

(72) Inventors: Dae-Ho KIM, Daejeon (KR); Tae-Gyu KANG, Daejeon (KR); You-Jin KIM, Daejeon (KR); Hyun-Joo KANG, Daejeon (KR); Hyun-Chul KANG, Daejeon (KR); Hyun-Seok KIM, Daejeon (KR); Hyun-Jong KIM, Cheongju-si Chungcheongbuk-do (KR)

(21) Appl. No.: 14/525,831

(22) Filed: Oct. 28, 2014

(30) Foreign Application Priority Data
Oct. 29, 2013 (KR) 10-2013-0129375
Jul. 28, 2014 (KR) 10-2014-0095561

(51) Int. Cl. H05B 37/02

(52) U.S. Cl. CPC H05B 37/02
USPC 315/294

(57) ABSTRACT

Disclosed herein is an apparatus and method for controlling lighting based on an Internet Protocol (IP) network. Pieces of input information required to control lighting devices connected to a Digital Addressable Lighting Interface (DALI) network are received. An event corresponding to an IP packet, provided via network input among the pieces of the input information, is generated and is converted into a format of a DALI command. Time synchronization for the DALI command is performed while operating in conjunction with a DALI timer. A lighting device connected to the DALI network is controlled in compliance with the DALI command, for which time synchronization has been completed.

### CROSS REFERENCE TO RELATED APPLICATIONS

This application claims the benefit of Korean Patent Application Nos. 10-2013-0129375, filed Oct. 29, 2013 and 10-2014-0095561, filed Jul. 28, 2014, which are hereby incorporated by reference in their entirety into this application.

### BACKGROUND OF THE INVENTION

1. Technical Field

The present invention relates generally to an apparatus and method for controlling lighting based on an Internet Protocol (IP) network and, more particularly, to an apparatus and method that control lighting devices connected to a Digital Addressable Lighting Interface (DALI) network corresponding to a lighting network based on an IP network corresponding to a data communication network.

2. Description of the Related Art

A DALI communication standard enables scenes corresponding to a plurality of combinations to be set by allocating addresses to respective lighting devices or allocating addresses on a group basis, and thus lighting devices capable of meeting user requirements can be implemented.

DALI communication is driven at low voltage using a bus composed of two wires, and even 64 DALI interfaces can be connected to one DALI bus to enable communication. DALI communication is used to monitor and control the status of components connected to the DALI system through a DALI interface. The status of components that can be monitored and controlled via DALI communication may include a state indicating whether the components are malfunctioning, a state indicating the occurrence of a fire caused by sensors or the occurrence of security problems, etc.

Messages used in the DALI system have the format of a serial data stream, and are each divided into an address part and a command part. Each DALI device uses digital data by which “0” and “1” are represented by two different types of voltage levels, and performs communication using its own address in the form of a broadcast. Typically, DALI communication can set 64 addresses and 16 group addresses.

In this way, in a DALI communication environment, synchronization between lighting systems is impossible, and thus there is required technology capable of controlling a lighting system connected to a lighting network at any time and from anywhere. In connection with this, Korean Patent Application Publication No. 10-2012-0095153 discloses a technology related to “Light control device and method based on DALI communication.”

### SUMMARY OF THE INVENTION

Accordingly, the present invention has been made keeping in mind the above problems occurring in the prior art, and an object of the present invention is to provide an apparatus and method that control lighting devices connected to a DALI network corresponding to a lighting network, based on an IP network corresponding to a data communication network.

In accordance with an aspect of the present invention to accomplish the above object, there is provided a method for controlling lighting based on an Internet Protocol (IP) network, including receiving pieces of input information required to control lighting devices connected to a Digital Addressable Lighting Interface (DALI) network; generating an event corresponding to an IP packet, provided via network input among the pieces of the input information, and converting the generated event into a format of a DALI command; performing time synchronization for the DALI command while operating in conjunction with a DALI timer; and controlling a lighting device connected to the DALI network in compliance with the DALI command, for which time synchronization has been completed.

Converting the generated event may include generating the event when the IP packet is received, and storing the event in a specific field.

The IP packet may correspond to pieces of switch control information corresponding to the lighting devices connected to the DALI network.

Converting the generated event may include converting at least one of an IP interface configuration event, a remote Direct Arc Power Control (DAPC) event, a remote control command event, and a reserved event into a format of a DALI command.

The IP interface configuration event may include an authentication request event and a reserved event.

The remote control command event may include an off event, a up event, a down event, a step up event, a step down event, a recall maximum level event, a recall minimum level event, a reserved event and a go to scene event.

The method may further include, after controlling the lighting device, receiving results of controlling the lighting device, and performing time synchronization for the lighting control results while operating in conjunction with an IP timer; and converting the lighting control results, for which time synchronization has been completed, into IP data, and transferring the IP data through an IP network.

Transferring the IP data through the IP network may include setting the IP network or querying about the IP network before transferring the IP data through the IP network.

In accordance with another aspect of the present invention to accomplish the above object, there is provided an apparatus for controlling lighting based on an IP network, including a Digital Addressable Lighting Interface (DALI) input unit for receiving pieces of input information required to control lighting devices connected to a DALI network; an IP interface unit for generating an event corresponding to an IP packet, provided via network input among the pieces of the input information, converting the generated event into a format of a DALI command, and performing time synchronization for the DALI command while operating in conjunction with a DALI timer; and a lighting control unit for controlling a lighting device connected to the DALI network in compliance with the DALI command, for which time synchronization has been completed.

The IP packet may correspond to pieces of switch control information corresponding to the lighting devices connected to the DALI network.

The apparatus may further include an application control unit for controlling an application in compliance with the DALI command received from the IP interface unit.

The IP interface unit may include an IP packet transmission/reception unit for receiving the IP packet, provided via network input among the pieces of the input information of the DALI input unit; an IP processing unit for generating an event when the IP packet is received, and storing the event in a specific field; a status manager unit for managing the DALI command while operating in conjunction with an interface timer unit including the DALI timer; and a DALI frame transmission/reception unit for transferring the DALI command, for which time synchronization has been completed, to the lighting control unit.

The IP interface unit may further include an interface timer unit for including an IP timer based on the timer of the IP network and the DALI timer based on the timer of the DALI network.

The IP interface unit may further include a DALI processing unit for converting light control results received through the DALI frame transmission/reception unit into a format of the IP packet.

The IP interface unit may convert at least one of an IP interface configuration event, a remote Direct Arc Power Control (DAPC) event, a remote control command event, and a reserved event into a format of a DALI command.

The IP interface configuration event may include an authentication request event and a reserved event.

The remote control command event may include an off event, a up event, a down event, a step up event, a step down event, a recall maximum level event, a recall minimum level event, a reserved event and a go to scene event.

The IP interface unit may receive results of controlling the lighting device through the lighting control unit, convert the received lighting control results into IP data, and transfer the IP data to a network user through the IP network.

The IP interface unit may perform time synchronization for the IP data while operating in conjunction with an IP timer, and transfers the IP data, for which time synchronization has been completed, to the network user through the IP network.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing an apparatus for controlling lighting based on an IP network according to an embodiment of the present invention;

FIG. 2 is a diagram showing the configuration of a DALI input unit according to an embodiment of the present invention;

FIG. 3 is a diagram showing the configuration of an IP interface unit according to an embodiment of the present invention;

FIG. 4 is a flowchart showing a method for controlling lighting based on an IP network according to an embodiment of the present invention;

FIG. 5 is a diagram showing the format of a timer according to an embodiment of the present invention;

FIG. 6 is a diagram showing an event generated by an IP interface unit according to an embodiment of the present invention;

FIG. 7 is a diagram showing an interface configuration event according to an embodiment of the present invention;

FIG. 8 is a diagram showing a remote control command event according to an embodiment of the present invention; and

FIG. 9 is a diagram showing the definition of the value of a variable ipDhcp according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, an apparatus and method for controlling lighting connected to a DALI network corresponding to a lighting network, based on an IP network corresponding to a data communication network according to embodiments of the present invention will be described in detail with reference to the attached drawings.

First, an apparatus for controlling lighting based on an IP network according to an embodiment of the present invention may control lighting in a DALI structure corresponding to an Open Systems Interconnection model (OSI) layer structure in A.6 Communication layer structure overview section of International Electrotechnical Commission (IEC) 62386, but the apparatus is not limited to such a structure.

In the OSI layer structure, a forward frame and a backward frame must be mapped to an IP interface defined by IEC 62386 Part 306. Further, in the OSI layer model of ISO/IEC 7498-1, Transmission Control Protocol/Internet Protocol (TCP/IP) is most widely used, and 802.3 Ethernet-based physical/link layers are used.

In the OSI layer structure, a network layer is used to process messages and addresses. In order to operate in conjunction with a TCP/IP stack, the network layer must be able to accommodate a logical address system structure defined in IEC 62386 Part 102 and 103. IEC 62386 Part 101 defines a 16-bit forward frame and IEC 62386 Part 103 defines a 24-bit forward frame. Further, the network layer must be able to accommodate an 8-bit frame that is a backward frame, as a TCP/IP payload.

A transport layer provides a function of securely exchanging information and accommodates a lighting control command as the payload of TCP/User Datagram Protocol (UDP).

An application layer provides a function of removing errors through responses to TCP/UDP signals, the retransmission of signals, etc., and instances of the IP interface are configured in the application layer.

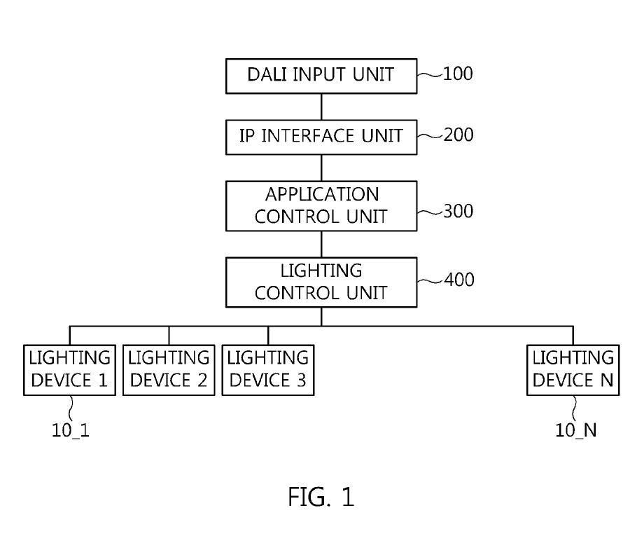

Below, the apparatus for controlling lighting based on the IP network will be described in detail with reference to FIG. 1.

FIG. 1 is a configuration diagram schematically showing an apparatus for controlling lighting based on an IP network according to an embodiment of the present invention.

Referring to FIG. 1, an apparatus for controlling lighting based on an IP network includes a DALI input unit 100, an IP interface unit 200, an application control unit 300, and a lighting control unit 400. Further, the lighting control apparatus based on an IP network controls a plurality of lighting devices 10_1 to 10_N connected to a DALI network corresponding to a lighting network.

The DALI input unit 100 receives pieces of switch control information corresponding to the plurality of lighting devices connected to the DALI network, that is, pieces of input information required to control the respective lighting devices.

The IP interface unit 200 functions to convert an IP packet, provided via network input among the pieces of input information of the DALI input unit 100, into a DALI command in conformity with the DALI network, or convert lighting control results, received through the DALI network, into an IP packet in conformity with the IP network, and provide the DALI command or the IP packet to a network user.

The application control unit 300 controls the corresponding application in compliance with the DALI command received from the IP interface unit 200.

The lighting control unit 400 controls a corresponding one of the plurality of lighting devices 10_1 to 10_N connected to the DALI network, based on the results of controlling the application.

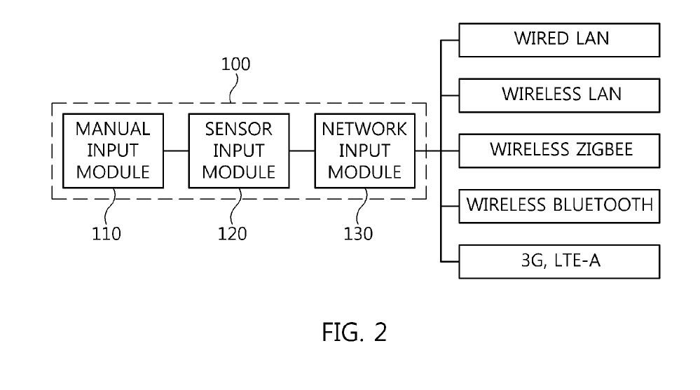

Below, the DALI input unit 100 will be described in detail with reference to FIG. 2.

FIG. 2 is a diagram showing the configuration of the DALI input unit according to an embodiment of the present invention.

Referring to FIG. 2, the DALI input unit 100 includes a manual input module 110, a sensor input module 120, and a network input module 130.

The manual input module 110 corresponds to a push button, a binary input (IEC 62386 Part 301), and analog rotaries and sliders (IEC 62386 Part 302).

The sensor input module 120 receives sensed results through recognition sensors (presence and absence detectors) (IEC 62386 Part 303), an illuminance sensor (light level sensor) (IEC 62386 Part 304), a color temperature sensor (color sensor) (IEC 62386 Part 305), etc.

The network input module 130 receives IP packets through various types of networks, for example, a wired Local Area Network (LAN), a WiFi network, a Zigbee network, a Bluetooth network, or a 3rd generation/Long Term Evolution-Advanced (LTE-A) network, via network input, for example, an IP interface (IEC 62386 Part 306).

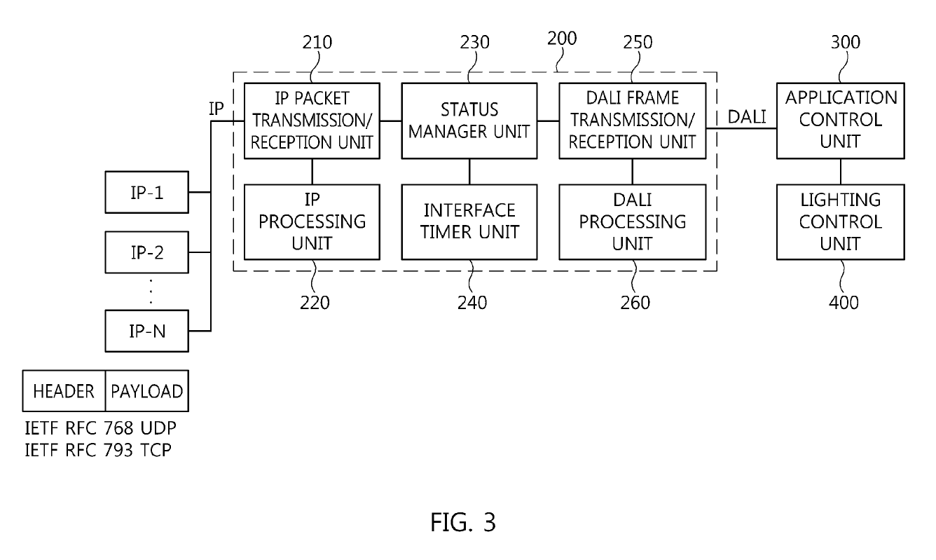

Below, a configuration in which the IP interface unit 200 processes the input information of the DALI input unit 100, that is, IP packets, will be described in detail with reference to FIG. 3.

FIG. 3 is a diagram showing the configuration of the IP interface unit according to an embodiment of the present invention.

Referring to FIG. 3, the IP interface unit 200 includes an IP packet transmission/reception unit 210, an IP processing unit 220, a status manager unit 230, an interface timer unit 240, a DALI frame transmission/reception unit 250, and a DALI processing unit 260.

The IP packet transmission/reception unit 210 receives an IP packet, provided via network input, among pieces of input information of the DALI input unit 100.

The IP processing unit 220 generates an event corresponding to the IP packet received from the IP packet transmission/reception unit 210, and converts the generated event into the format of a DALI command. Here, the generated event is generated when the IP packet is received, and is stored in an inputValue field.

The status manager unit 230 manages the DALI command received from the IP processing unit 220 by means of the extension of commands and the definition of variables so that the DALI command may be used in conjunction with the DALI network while operating in conjunction with the interface timer unit 240.

Generally, in a DALI lighting control network structure which controls lighting using two electrical signal lines, technology for knowing a current time or performing synchronization between different lighting systems is not yet provided. More specifically, a microcomputer inserted into each lighting device is inexpensive and may have an internal timer function, but, in order to apply a current time, season variations, etc., a complicated operation is required. Therefore, by means of a Network Time Protocol (NTP: Internet Engineering Task Force (IETF) Request For Comments (RFC) 5905) used for the Internet, a time synchronization function for the overall network may be applied to the lighting control network. For this, the extension of commands and the definition of variables are required so as to operate in conjunction with the DALI network. Here, time variables may be divided into a type in which, when the application control unit 300 requires the setting of a timer, an event is generated and applied if a given time is reached, and a type in which control information for lighting is converted based on a current time.

The interface timer unit 240 includes an IP timer based on the timer of the IP network and a DALI timer based on the timer of the DALI network.

The DALI frame transmission/reception unit 250 transfers a DALI frame to the application control unit 300 through the DALI network and receives the results of lighting control corresponding to the DALI frame.

The DALI processing unit 260 converts the lighting control results received through the DALI frame transmission/reception unit 250 into the format of an IP packet.

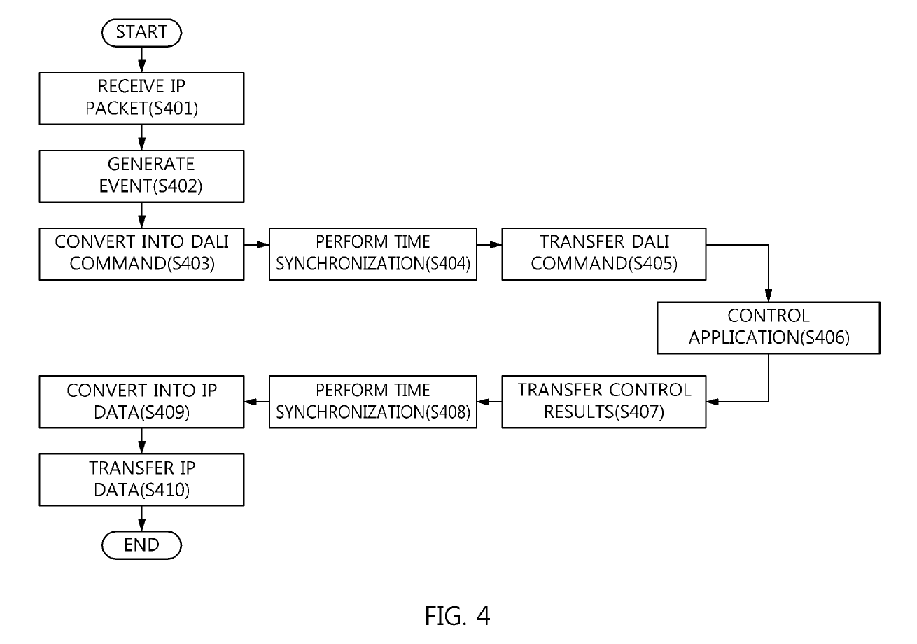

Hereinafter, a method for controlling lighting based on an IP network will be described in detail with reference to FIG. 4.

FIG. 4 is a flowchart showing a method for controlling lighting based on an IP network according to an embodiment of the present invention.

Referring to FIG. 4, the DALI input unit 100 receives an IP packet through the IP network at step S401. Here, the IP packet corresponds to pieces of switch control information corresponding to a plurality of lighting devices connected to the DALI network, that is, pieces of input information required to control the respective lighting devices.

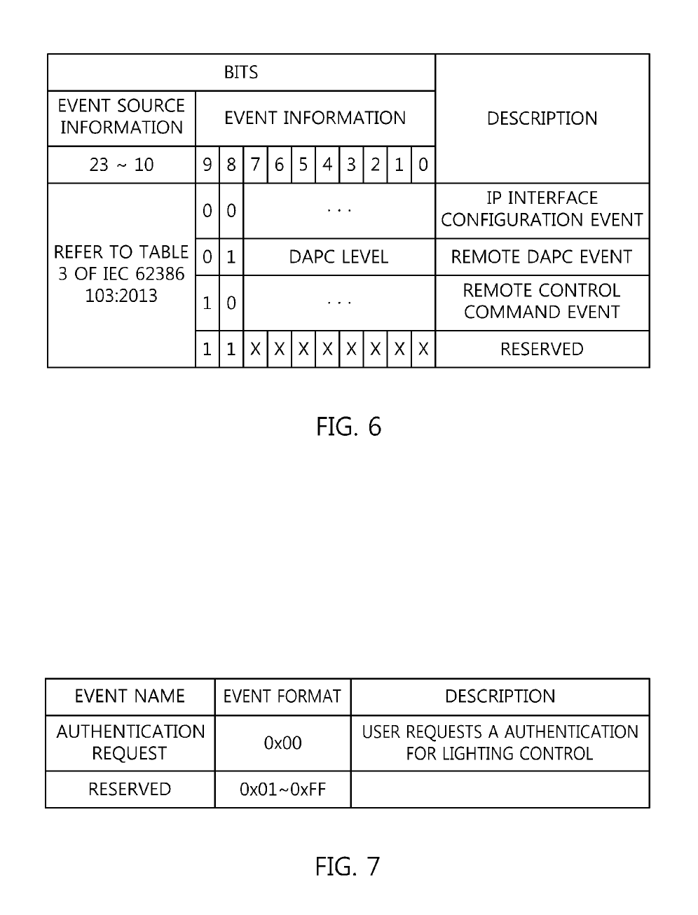

The IP interface unit 200 generates an event corresponding to the IP packet at step S402, and stores the event in an inputValue field. The event generated at step S402 is shown in FIG. 6.

Referring to FIG. 6, events are each composed of 24 bits and include an IP interface configuration event, a remote Direct Arc Power Control (DAPC) event, a remote control command event, and a reserved event.

The IP interface configuration event includes an authentication request event and a reserved event, as shown in FIG. 7.

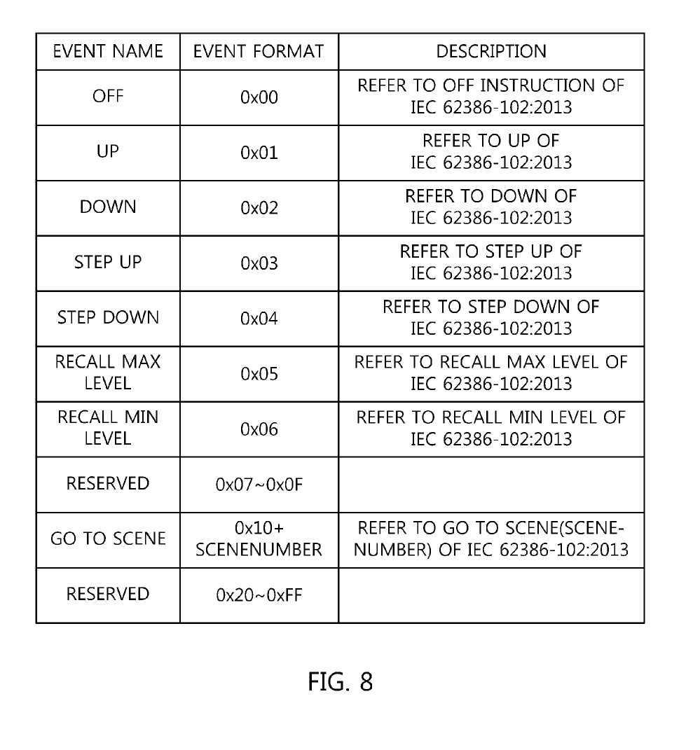

The remote control command event includes an off event which turns off the light, a up event which makes the light brighter, a down event which makes the light darker, a step up event which makes the light brighter step by step, a step down event which makes the light darker step by step, a recall maximum level event which recalls the predetermined maximum brightness of the light, a recall minimum level event which recalls the predetermined minimum brightness of the light, a reserved event and a go to scene event which turns on the light in the specific location or lighting, as shown in FIG. 8.

The IP interface unit 200 converts the event generated at step S402 into the format of a DALI command at step S403.

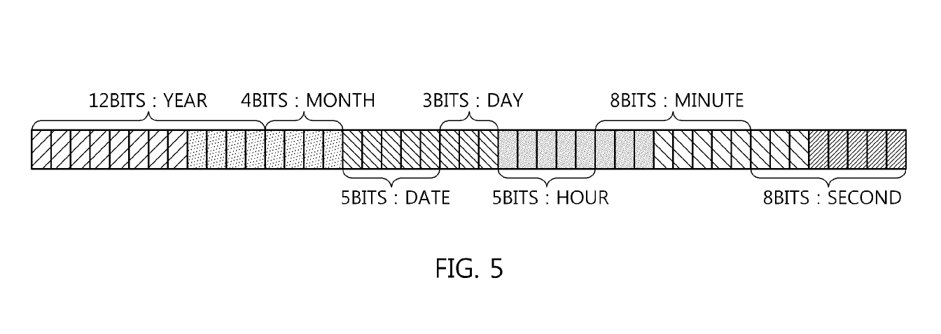

The IP interface unit 200 performs time synchronization while operating in conjunction with a timer such as that shown in FIG. 5 so that the DALI command may be used in conjunction with the DALI network at step S404.

The IP interface unit 200 transfers the DALI command to the application control unit 300 at step S405, and the application control unit 300 controls the corresponding application in compliance with the DALI command at step S406.

The lighting control unit 400 controls a corresponding one of the plurality of lighting devices 10_1 to 10_N connected to the DALI network, based on the results of controlling the application.

The application control unit 300 receives the results of controlling the corresponding lighting device (hereinafter also referred to as “lighting control results”) from the lighting control unit 400, and transfers the lighting control results to the IP interface unit 200 at step S407.

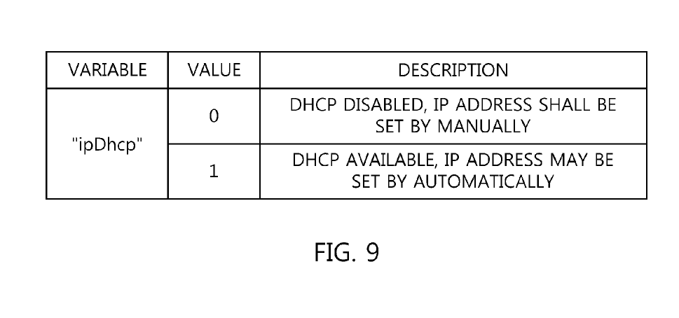

The application control unit 300 may set the configuration of the IP network via the IP interface unit 200 or query the IP interface unit 200 about the configuration of the IP network. Here, the IP network may use a Dynamic Host Configuration Protocol (DHCP) service so as to allocate the address of an IP interface. The status of DHCP must be stored in the variable “ipDhcp.” The values of the variable “ipDhcp” are defined, as shown in FIG. 9.

Referring to FIG. 9, the status of DHCP may be set using the command “SET IP DHCP STATUS (DTR0),” and may be checked using the command “QUERY IP DHCP STATUS.”

The IP address may be set using the command “SET IP ADDRESS V4 0-15 (DTR2:DTR1)” and the command “SET IP ADDRESS V4 16-31 (DTR2:DTR1)”, and may be queried using the commands “QUERY IP ADDRESS V4 0-7”, “QUERY IP ADDRESS V4 8-15”, “QUERY IP ADDRESS V4 16-23”, and “QUERY IP ADDRESS V4 24-31.” If the DHCP status variable “ipDhcp” is set to “1”, the setting commands “SET IP ADDRESS V4 0-15 (DTR2:DTR1)” and “SET IP ADDRESS V4 16-31 (DTR2:DTR1)” must be ignored.

The IP interface unit 200 performs time synchronization while operating in conjunction with the IP timer so that the lighting control results may be used in conjunction with the IP network at step S408.

The IP interface unit 200 converts the lighting control results, for which time synchronization has been completed, into IP data at step S409, and transfers the IP data through the IP network at step S410.

In this way, the present invention is advantageous in that it controls lighting devices connected to a DALI network corresponding to a lighting network, based on an IP network corresponding to a data communication network, thus making possible the control of lighting devices connected to the DALI network at any time and from anywhere.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method for controlling lighting based on an Internet Protocol (IP) network, comprising:
receiving pieces of input information required to control lighting devices connected to a Digital Addressable Lighting Interface (DALI) network;
generating an event corresponding to an IP packet, provided via network input among the pieces of the input information, and converting the generated event into a format of a DALI command;
performing time synchronization for the DALI command while operating in conjunction with a DALI timer; and
controlling a lighting device connected to the DALI network in compliance with the DALI command, for which time synchronization has been completed.

2. The method of claim 1, wherein converting the generated event comprises generating the event when the IP packet is received.

3. The method of claim 2, wherein converting the generated event further comprises storing the event in a specific field.

4. The method of claim 1, wherein the IP packet corresponds to pieces of switch control information corresponding to the lighting devices connected to the DALI network.

5. The method of claim 1, wherein converting the generated event comprises converting at least one of an IP interface configuration event, a remote Direct Arc Power Control (DAPC) event, a remote control command event, and a reserved event into a format of a DALI command.

6. The method of claim 5, wherein the IP interface configuration event comprises an authentication request event and a reserved event.

7. The method of claim 5, wherein the remote control command event comprises an off event, a up event, a down event, a step up event, a step down event, a recall maximum level event, a recall minimum level event, a reserved event and a go to scene event.

8. The method of claim 1, further comprising, after controlling the lighting device:
receiving results of controlling the lighting device, and performing time synchronization for the lighting control results while operating in conjunction with an IP timer; and
converting the lighting control results, for which time synchronization has been completed, into IP data, and transferring the IP data through an IP network.

9. The method of claim 8, wherein transferring the IP data through the IP network comprises setting the IP network or querying about the IP network before transferring the IP data through the IP network.

10. An apparatus for controlling lighting based on an IP network, comprising:
a Digital Addressable Lighting Interface (DALI) input unit configured to receive pieces of input information required to control lighting devices connected to a DALI network;
an IP interface unit configured to generate an event corresponding to an IP packet, provided via network input among the pieces of the input information, convert the generated event into a format of a DALI command, and perform time synchronization for the DALI command while operating in conjunction with a DALI timer; and
a lighting control unit configured to control a lighting device connected to the DALI network in compliance with the DALI command, for which time synchronization has been completed.

11. The apparatus of claim 10, wherein the IP packet corresponds to pieces of switch control information corresponding to the lighting devices connected to the DALI network.

12. The apparatus of claim 10, further comprising an application control unit configured to control an application in compliance with the DALI command received from the IP interface unit.

13. The apparatus of claim 10, wherein the IP interface unit comprises:
an IP packet transmission/reception unit configured to receive the IP packet, provided via network input among the pieces of the input information of the DALI input unit;
an IP processing unit configured to generate an event when the IP packet is received, and store the event in a specific field;
a status manager unit configured to manage the DALI command while operating in conjunction with an interface timer unit including the DALI timer; and
a DALI frame transmission/reception unit configured to transfer the DALI command, for which time synchronization has been completed, to the lighting control unit.

14. The apparatus of claim 13, further comprising an interface timer unit configured to include an IP timer based on the timer of the IP network and the DALI timer based on the timer of the DALI network.

15. The apparatus of claim 13, further comprising a DALI processing unit configured to convert light control results received through the DALI frame transmission/reception unit into a format of the IP packet.

16. The apparatus of claim 10, wherein the IP interface unit converts at least one of an IP interface configuration event, a remote Direct Arc Power Control (DAPC) event, a remote control command event, and a reserved event into a format of a DALI command.

17. The apparatus of claim 16, wherein the IP interface configuration event comprises an authentication request event and a reserved event.

18. The apparatus of claim 16, wherein the remote control command event comprises an off event, a up event, a down event, a step up event, a step down event, a recall maximum level event, a recall minimum level event, a reserved event and a go to scene event.

19. The apparatus of claim 10, wherein the IP interface unit receives results of controlling the lighting device through the lighting control unit, converts the received lighting control results into IP data, and transfers the IP data to a network user through the IP network.

20. The apparatus of claim 19, wherein the IP interface unit performs time synchronization for the IP data while operating in conjunction with an IP timer, and transfers the IP data, for which time synchronization has been completed, to the network user through the IP network.
